(19) United States
(12) Patent Application Publication
(10) Pub. No.: US 2015/0081353 A1
(43) Pub. Date: Mar. 19, 2015

(54) Systems and Methods for Interest-Driven Business Intelligence Systems Including Segment Data

(71) Applicant: Platfora, Inc., San Mateo, CA (US)

(72) Inventors: John Schuster, Los Altos Hills, CA (US); Benjamin Mark Werther, Burlingame, CA (US); Brian Babcock, Mountain View, CA (US); Kevin Scott Beyer, San Franciscoca, CA (US); Hans-Frederick Brown, San Rafael, CA (US); Carl-Christian Kanne, Campbell, CA (US); Jenn Rhim, Belmont, CA (US); Peter Schlampp, Burlingame, CA (US)

(73) Assignee: Platfora, Inc., San Mateo, CA (US)

(21) Appl. No.: 14/197,510

(22) Filed: Mar. 5, 2014

Related U.S. Application Data
(60) Provisional application No. 61/894,356, filed on Oct. 22, 2013.
(60) Provisional application No. 61/880,051, filed on Sep. 19, 2013.

(51) Int. Cl. G06Q 10/06

(52) U.S. Cl. CPC G06Q 10/063
USPC 705/7.11

(57) ABSTRACT

Systems and methods for interest-driven business intelligence systems including segment data in accordance with embodiments of the invention are illustrated. In one embodiment, an interest-driven data visualization system includes a processor and a memory wherein an interest-driven data visualization application configures the processor to define reporting data requirements, including at least one piece of reporting data metadata, generate data retrieval job data, transmit the data retrieval job data to an interest-driven business intelligence server system, receive source data from the interest-driven business intelligence server system, create at least one piece of reporting data using the received source data, the data description metadata, and the reporting data metadata, and generate a set of segment data based on the reporting data, where a piece of segment data in the set of segment data includes a subset of the reporting data.

### CROSS-REFERENCE TO RELATED APPLICATIONS

The current application claims priority to U.S. Provisional Patent Application Ser. No. 61/894,356, filed Oct. 22, 2013 and to U.S. Provisional Patent Application Ser. No. 61/880,051, filed Sep. 19, 2013, the disclosures of which are hereby incorporated by reference in their entirety.

### BACKGROUND

The term “business intelligence” is commonly used to refer to techniques for identifying, processing, and analyzing business data. Business intelligence systems can provide historical, current, and predictive views of business operations. Business data, generated during the course of business operations, including data generated from business processes and the additional data created by employees and customers, may be structured, semi-structured, or unstructured depending on the context and knowledge surrounding the data. In many cases, data generated from business processes is structured, whereas data generated from customer interactions with the business is semi-structured or unstructured. Due to the amount of data generally generated during the course of business operations, business intelligence systems are commonly built on top of and utilize a data warehouse.

Data warehouses are utilized to store, analyze, and report data; for example, business data. Data warehouses utilize databases to store, analyze, and harness the data in a productive and cost-effective manner. A variety of databases are commonly utilized including a relational database management system (RDBMS), such as the Oracle Database from the Oracle Corporation of Santa Clara, Calif., or a massively parallel processing analytical database, such as Teradata from the Teradata Corporation of Miamisburg, Ohio. Business intelligence (BI) and analytical tools, such as SAS from SAS Institute, Inc. of Cary, N.C., are used to access the data stored in the database and provide an interface for developers to generate reports, manage and mine the stored data, perform statistical analysis, business planning, forecasting, and other business functions. Most reports created using BI tools are created by database administrators and/or business intelligence specialists, and the underlying database may be tuned for the expected access patterns. A database administrator may index, pre-aggregate or restrict access to specific relations, allow ad-hoc reporting and exploration.

A snowflake schema is an arrangement of tables in a RDBMS, with a central fact table connected to one or more dimension tables. The dimension tables in a snowflake schema are normalized into multiple related tables—for a complex schema there will be many relationships between the dimension tables, resulting in a schema that looks like a snowflake. A star schema is a specific form of a snowflake schema having a fact table referencing one or more dimension tables. However, in a star schema, the dimensions are normalized into a single table—the fact table is the center and the dimension tables are the “points” of the star.

Online transaction processing (OLTP) systems are designed to facilitate and manage transaction-based applications. OTLP may refer to a variety of transactions such a database management system transactions, business, or commercial transactions. OLTP systems typically have low latency response to user requests.

Online analytical processing (OLAP) is an approach to answering multidimensional analytical queries. OLAP tools enable users to analyze multidimensional data utilizing three basic analytical operations: consolidation (aggregating data), drill-down (navigating details of data), and slice and dice (take specific sets of data and view from multiple viewpoints). The basis for many OLAP systems is an OLAP cube. An OLAP cube is a data structure allowing for fast analysis of data with the capability of manipulating and analyzing data from multiple perspectives. OLAP cubes are typically composed of numeric facts, called measures, categorized by dimensions. These facts and measures are commonly created from a star schema or a snowflake schema of tables in a RDBMS.

### SUMMARY OF THE INVENTION

Systems and methods for interest-driven business intelligence systems including segment data in accordance with embodiments of the invention are illustrated. In one embodiment, an interest-driven data visualization system includes a processor and a memory connected to the processor and configured to store an interest-driven data visualization application, wherein the interest-driven data visualization application configures the processor to define reporting data requirements, where the reporting data requirements include at least one piece of reporting data metadata, generate data retrieval job data based on the at least one piece of reporting data metadata in the reporting data requirements and the data description metadata, transmit the data retrieval job data to an interest-driven business intelligence server system, receive source data from the interest-driven business intelligence server system, where the source data is generated based on raw data and metadata describing the raw data, create at least one piece of reporting data using the received source data, the data description metadata, and the reporting data metadata, and generate a set of segment data based on the reporting data, where a piece of segment data in the set of segment data includes a subset of the reporting data.

In another embodiment of the invention, the source data includes data selected from the group consisting of aggregate data and event-oriented data.

In an additional embodiment of the invention, the interest-driven data visualization application further configures the processor to associate visualization metadata with the segment data, where the visualization metadata describes the visual appearance of the at least one piece of segment data and generate a report using the at least one piece of segment data and the visualization metadata, where the generated report is configured to be displayed using a display device.

In yet another additional embodiment of the invention, the interest-driven data visualization application configures the processor to generate supplemental data retrieval job data identifying additional source data, transmit the supplemental data retrieval job data to the interest-driven business intelligence server system, receive supplemental source data from the interest-driven business intelligence server system, update at least one piece of the at least one piece of reporting data using the supplemental source data, the data description metadata, and the reporting data metadata, and generate at least one piece of updated segment data in the set of segment data based on the updated reporting data.

In still another additional embodiment of the invention, the interest-driven data visualization application further configures the processor to generate an updated report using the at least one piece of updated segment data and the visualization metadata, where the generated report is configured to be displayed using a display device.

In yet still another additional embodiment of the invention, the interest-driven data visualization application further configures the processor to identify common data between a plurality of pieces of segment data within the set of segment data and generate a set of composite segment data including a portion of the pieces of segment data sharing the identified common data.

In yet another embodiment of the invention, the interest-driven data visualization application further configures the processor to associate visualization metadata with the composite segment data, where the visualization metadata describes the visual appearance of the at least one piece of composite segment data and generate a composite segment report based on the at least one piece of composite segment data and the visualization metadata, where the composite segment report is configured to be displayed using a display device.

In still another embodiment of the invention, the interest-driven data visualization application configures the processor to generate a set of segment data by identifying segment grouping data based on the reporting data metadata and the reporting data and grouping the reporting data based on the segment grouping data.

In yet still another embodiment of the invention, the segment grouping data identifies at least one dimension within the reporting data.

In yet another additional embodiment of the invention, the segment data includes a subset of the reporting data having at least one dimension satisfying a portion of the segment grouping data and the segment grouping data identifies a set of data within the reporting data selected from the group consisting of dimension data and fact data.

In still another additional embodiment of the invention, the interest-driven data visualization application further configures the processor to generate a set of segment data by determining filter data, where the filter data identifies a portion of the reporting data and filtering the reporting data utilized in the grouping of the reporting data based on the segment grouping data.

In yet still another additional embodiment of the invention, the interest-driven data visualization application further configures the processor to generate a set of segment data by creating segment data metadata describing the desired segment data, where the segment data metadata includes the segment grouping data, creating segment data request data including the segment data metadata, transmitting the segment data request data to an interest-driven business intelligence server system, and obtaining the segment data from the interest-driven business intelligence server system.

In yet another embodiment of the invention, the interest-driven data visualization application further configures the processor to identify at least one piece of segment data in the set of segment data, generate segment data retrieval job data based on the at least one piece of segment data, transmit the segment data retrieval job data to the interest-driven business intelligence server system, obtain additional source data corresponding to the segment data retrieval job data, and generate segment reporting data based on the additional source data.

Still another embodiment of the invention includes an interest-driven business intelligence system including raw data storage configured to contain raw data and perform extract, transform, and load (ETL) processes, where the raw data includes unstructured data, a data mart configured to contain metadata that describes the raw data, and an intermediate processing layer, wherein the intermediate processing layer is configured to automatically generate metadata describing the raw data, derive reporting data requirements from at least one report specification based on the metadata, and compile an interest-driven data pipeline based upon the reporting data requirements, and wherein compiling the interest-driven data pipeline includes generating ETL processing jobs to generate source data from the raw data by filtering the raw data using the structure of the raw data, applying transformations to the raw data based on the structure of the raw data, and storing the source data in the data mart, and generate a set of segment data based on segment data metadata and the generated source data.

In yet another additional embodiment of the invention, the source data includes data selected from the group consisting of aggregate data and event-oriented data.

In still another additional embodiment of the invention, the intermediate processing layer is further configured to generate supplemental source data utilizing the interest-driven data pipeline and generate at least one piece of updated segment data in the set of segment data based on the segment data metadata and the supplemental source data.

In yet still another additional embodiment of the invention, the intermediate processing layer is further configured to identify common data between a plurality of pieces of segment data within the set of segment data and generate a set of composite segment data including a portion of the pieces of segment data sharing the identified common data.

In yet another embodiment of the invention, the intermediate processing layer is further configured to generate a set of segment data by identifying segment grouping data based on the segment data metadata and grouping the source data based on the segment grouping data.

In still another embodiment of the invention, the segment grouping data identifies at least one dimension within the source data.

In yet still another embodiment of the invention, the segment data includes a subset of the reporting data having at least one dimension satisfying a portion of the segment grouping data and the segment grouping data identifies a set of data within the reporting data selected from the group consisting of dimension data and fact data.

In yet another additional embodiment of the invention, the intermediate processing layer is further configured to generate a set of segment data by determining filter data, where the filter data identifies a portion of source data and filtering the source data utilized in the grouping of the source data based on the segment grouping data.

In still another additional embodiment of the invention, wherein the intermediate processing layer is further configured to obtain segment data request data, where the segment data request data includes segment data metadata including segment grouping data and generate the set of segment data based on the segment data metadata and the source data present in the data mart.

In yet still another embodiment of the invention, the intermediate processing layer is further configured to identify additional source data based on the segment data metadata, where the additional source data is not present in the data mart, generate ETL processing jobs to generate the additional source data, obtaining the additional source data by transmitting the generated ETL processing jobs to the raw data storage, and generating at least one piece of segment data in the set of segment data based on the additional source data.

In yet another additional embodiment of the invention, the segment data request data further includes filtering data and the intermediate processing layer is further configured to filter the source data utilized in the generation of the set of segment data based on the filtering data.

In still another additional embodiment of the invention, the segment data request data further includes metadata identifying an interest-driven data visualization system and the intermediate processing layer is further configured to transmit the generated segment data to the identified interest-driven data visualization system.

In yet still another additional embodiment of the invention, the intermediate processing layer is further configured to obtain segment data retrieval job data, where the segment retrieval job data identifies at least one piece of segment data, identify additional source data based on the segment data metadata and the source data contained within the data mart, when the additional source data is not present in the data mart, generate ETL processing jobs to generate the additional source data, and obtain the additional source data by transmitting the generated ETL processing jobs to the raw data storage, and generate at least one piece of source data based on the segment data retrieval job data and the additional source data.

Yet another embodiment of the invention includes a method for creating interest-driven data visualizations with segment data, including defining reporting data requirements using an interest-driven data visualization system, where the reporting data requirements include at least one piece of reporting data metadata, generating data retrieval job data based on the at least one piece of reporting data metadata in the reporting data requirements and the data description metadata using the interest-driven data visualization system, transmitting the data retrieval job data to an interest-driven business intelligence server system using the interest-driven data visualization system, receiving source data from the interest-driven business intelligence server system using the interest-driven data visualization system, where the source data is generated based on raw data and metadata describing the raw data, creating at least one piece of reporting data based on the received source data, the data description metadata, and the reporting data metadata using the interest-driven data visualization system, and generating a set of segment data based on the reporting data using the interest-driven data visualization system, where a piece of segment data in the set of segment data includes a subset of the reporting data.

### BRIEF DESCRIPTION OF THE DRAWINGS

FIG. 1 is a network diagram of an interest-driven business intelligence system in accordance with an embodiment of the invention.

FIG. 2A is a conceptual illustration of an interest-driven business intelligence server system in accordance with an embodiment of the invention.

FIG. 2B is a conceptual illustration of an interest-driven data visualization system in accordance with an embodiment of the invention.

FIG. 3A is a conceptual illustration of an interface for defining segment data in accordance with an embodiment of the invention.

FIG. 3B is a conceptual illustration of an interface for exploring composite segment data in accordance with an embodiment of the invention.

FIG. 4 is a flow chart illustrating a process for creating segment data in accordance with an embodiment of the invention.

FIG. 5 is a flow chart illustrating a process for creating composite segment data in accordance with an embodiment of the invention.

FIG. 6 is a flow chart illustrating a process for generating segment data in accordance with an embodiment of the invention.

FIG. 7 is a flow chart illustrating a process for generating reporting data based on segment data in accordance with an embodiment of the invention.

### DETAILED DISCLOSURE OF THE INVENTION

Turning now to the drawings, interest-driven business intelligence systems configured to utilize segment data in accordance with embodiments of the invention are illustrated. Interest-driven business intelligence systems include interest-driven business intelligence server systems configured to create reporting data using raw data retrieved from distributed computing platforms. The interest-driven business intelligence server systems are configured to dynamically compile interest-driven data pipelines to provide analysts with information of interest from the distributed computing platform. The interest-driven business intelligence server system has the ability to dynamically recompile the interest-driven data pipeline to provide access to desired information stored in the distributed computing platform. An interest-driven data pipeline is dynamically compiled to create reporting data based on reporting data requirements determined by analysts utilizing interest-driven data visualization systems within the interest-driven business intelligence system. Changes specified at the report level can be automatically compiled and traced backward by the interest-driven business intelligence server system to compile an appropriate interest-driven data pipeline to meet the new and/or updated reporting data requirements. Interest-driven business intelligence server systems further build metadata concerning the data available within the interest-driven business intelligence system and provide the metadata to interest-driven data visualization systems to enable the construction of reports using the metadata. In this way, interest-driven business intelligence server systems are capable of managing huge datasets in a way that provides analysts with complete visibility into the available data. Available data within an interest-driven business intelligence system includes any data present within an interest-driven business intelligence server system and/or a distributed computing platform. Interest-driven business intelligence systems and interest-driven business intelligence server systems that can be utilized in accordance with embodiments of the invention are discussed further in U.S. Pat. No. 8,447,721, titled “Interest-Driven Business Intelligence Systems and Methods of Data Analysis Using Interest-Driven Data Pipelines” and filed Feb. 29, 2012, the entirety of which is incorporated herein by reference.

Business intelligence systems, including interest-driven business intelligence systems in accordance with embodiments of the invention are configured to provide segment data that can be explored using interest-driven data visualization systems. In a variety of embodiments, segment data includes data grouped by one or more pieces of segment grouping data. This segment grouping data can be utilized in the exploration of the segment data to quickly identify patterns of interest within the data. The data utilized within the segment data can be sourced from a variety of pieces of data, including source data, aggregate data, event-oriented data, and reporting data as appropriate to the requirements of specific applications in accordance with embodiments of the invention. Additionally, multiple segments can be combined together in order to explore patterns existing across multiple segments for one or more pieces of reporting data. Based on patterns identified within the (combined) segment data, specific pieces of reporting data can be generated targeting the identified patterns within the segment data. This reporting data can then be utilized to generate detailed reports for additional analysis and exploration of the patterns located within the (combined) segment data. In a variety of embodiments, metadata describing the (combined) segment data can be stored and utilized to generate updated segment data. This updated segment data can be utilized to further analyze patterns occurring within the reporting data as the underlying reporting data changes.

Reports can be created using interest-driven data visualization systems configured to request and receive data from an interest-driven business intelligence server system. Systems and methods for interest-driven data visualization that can be utilized in accordance with embodiments are described in U.S. patent application Ser. No. 13/791,028, titled “Systems and Methods for Interest-Driven Data Visualization Systems Utilized in Interest-Driven Business Intelligence Systems” and filed Mar. 8, 2013, the entirety of which is hereby incorporated by reference. In order for an interest-driven data visualization system to build reports, a set of reporting data requirements are defined. These requirements specify the reporting data (derived from raw data) that will be utilized to generate the reports. The raw data can be structured, semi-structured, or unstructured. In a variety of embodiments, structured and semi-structured data include metadata, such as an index or other relationships, describing the data; unstructured data lacks any definitional structure. An interest-driven business intelligence server system can utilize reporting data already created by the interest-driven business intelligence server systems and/or cause new and/or updated reporting data to be generated to satisfy the reporting data requirements. In a variety of embodiments, reporting data requirements are obtained from interest-driven data visualization systems based on reporting requirements defined by analysts exploring metadata describing data stored within the interest-driven business intelligence system.

The data requested in the reporting data requirements can include any of a variety of source data available from an interest-driven business intelligence server system. In a number of embodiments, the raw data, aggregate data, event-oriented data, and/or filtered data is provided to interest-driven business intelligence server systems as source data. In many embodiments, the source data is described by metadata describing the raw data, aggregate data, event-oriented data, and/or filtered data present in the source data. In several embodiments, the source data, aggregate data, event-oriented data, and/or reporting data is stored in a data mart or other aggregate data storage associated with the interest-driven business intelligence server system. Interest-driven business intelligence server systems can load source data into a variety of reporting data structures in accordance with a number of embodiments, including, but not limited to, online analytical processing (OLAP) cubes. In a variety of embodiments, the reporting data structures are defined using reporting data metadata describing a reporting data schema. In a number of embodiments, interest-driven business intelligence server systems are configured to combine requests for one or more OLAP cubes into a single request, thereby reducing the time, storage, and/or processing power utilized by the interest-driven business intelligence system in creating source data utilized to create reporting data schemas and/or the reporting data.

Interest-driven business intelligence server systems are configured to provide reporting data based on one or more reporting data requirements. Reporting data provided by interest-driven business intelligence server systems includes raw data, aggregate data, event-oriented data, and/or filtered data loaded from raw data storage that has been processed and loaded into a data structure to provide rapid access to the data. Event-oriented data includes sets of data aligned along one or more of the dimensions of (e.g. columns of data within) the sets of data. Sets of data include, but are not limited to, fact tables and dimension tables as appropriate to the requirements of specific applications in accordance with embodiments of the invention. In this way, event-oriented data can include a variety of data across multiple sets of data that are organized by ordering data. Interest-driven business intelligence systems that are configured to utilize event-oriented data that can be utilized in accordance with embodiments of the invention are discussed further in U.S. Provisional Patent Application Ser. No. 61/894,186, titled “Systems and Methods for Interest-Driven Business Intelligence Systems Including Event-Oriented Data” and filed Oct. 22, 2013, the disclosure of which is hereby incorporated by reference in its entirety.

Although the systems and methods described below incorporate data including facts and dimensions, any of a variety of data, including data with other relationships, can be utilized as appropriate to the requirements of specific applications in accordance with embodiments of the invention. Systems and methods for interest-driven business intelligence systems including segment data in accordance with embodiments of the invention are described below.

### Interest-Driven Business Intelligence Systems

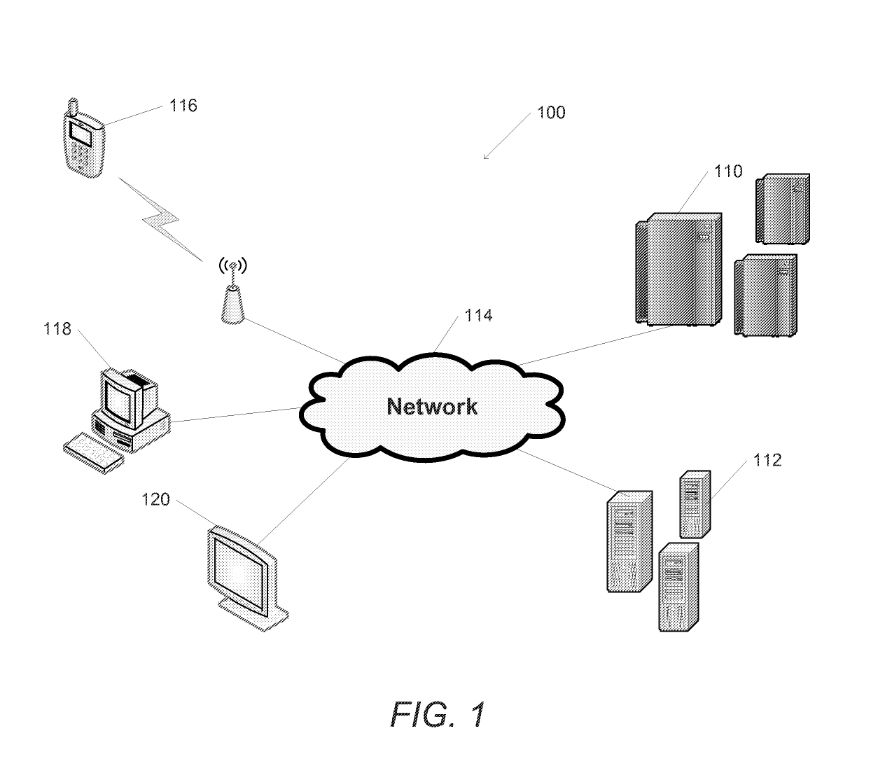

An interest-driven business intelligence system in accordance with an embodiment of the invention is illustrated in FIG. 1. The interest-driven business intelligence system 100 includes a distributed computing platform 110 configured to store raw business data. The distributed computing platform 110 is configured to communicate with an interest-driven business intelligence server system 112 via a network 114. In several embodiments of the invention, the network 114 is a local area network, a wide area network, or the Internet; any network 114 can be utilized as appropriate to the requirements of specific applications in accordance with embodiments of the invention. In a variety of embodiments, the distributed computing platform 110 is a cluster of computing devices configured as a distributed computing platform. The distributed computing platform 110 can be configured to act as a raw data storage system and a data warehouse within the interest-driven business intelligence system. In a number of embodiments, the distributed computing platform includes a distributed file system configured to distribute the data stored within the distributed computing platform 110 across the cluster computing devices. In many embodiments, the distributed data is replicated across the computing devices within the distributed computing platform, thereby providing redundant storage of the data. The distributed computing platform 110 is configured to retrieve data from the computing devices by identifying one or more of the computing devices containing the requested data and retrieving some or all of the data from the computing devices. In a variety of embodiments where portions of a request for data are stored using different computing devices, the distributed computing platform 110 is configured to process the portions of data received from the computing devices in order to build the data obtained in response to the request for data. Any distributed file system, such as the Hadoop Distributed File System (HDFS), can be utilized as appropriate to the requirements of specific applications in accordance with embodiments of the invention. In several embodiments, the interest-driven business intelligence server system 112 is implemented using one or a cluster of computing devices. In a variety of embodiments, alternative distributed processing systems are utilized. Raw data storage is utilized to store raw data, metadata storage is utilized to store data description metadata describing the raw data, and/or report storage is utilized to store previously generated reports including previous reporting data and previous reporting data requirements. Raw data storage, metadata storage, and/or report storage can be a portion of the memory associated with the interest-driven business intelligence server system 112, the distributed computing platform 110, and/or a separate device in accordance with the specific requirements of specific embodiments of the invention.

The interest-driven business intelligence server system 112 is configured to communicate via the network 114 with one or more interest-driven data visualization systems, including, but not limited to, cellular telephones 116, personal computers 118, and presentation devices 120. In many embodiments of the invention, interest-driven data visualization systems include any computing device capable of receiving and/or displaying data. Interest-driven data visualization systems enable users to specify reports including data visualizations that enable the user to explore the raw data stored within the distributed computing platform 110 using reporting data generated by the interest-driven business intelligence server system 112. Reporting data is provided in a variety of forms, including, but not limited to, snowflake schemas and star schemas as appropriate to the requirements of specific applications in accordance with embodiments of the invention. In many embodiments, reporting data is any data that includes fields of data populated using data stored within the distributed computing platform 110.

Based on received reporting data requirements, the interest-driven business intelligence server system 112 automatically compiles one or more interest-driven data pipelines to create or update reporting data to satisfy the received reporting data requirements. The interest-driven business intelligence server system 112 is configured to compile one or more interest-driven data pipelines configured to create and push down jobs to the distributed computing platform 110 to create source data and then applying various filtering, aggregation, and/or alignment processes to the source data to produce reporting data to be transmitted to interest-driven data visualization systems.

The interest-driven business intelligence server system 112 and/or the interest-driven data visualization systems are configured to create segment data identifying groupings of data within the data stored on the system. In several embodiments, the interest-driven business intelligence server system 112 is configured to create segment data based on segment data metadata. The segment data metadata is commonly obtained from an interest-driven data visualization system, where the segment data metadata is defined as reporting data is explored via the interest-driven data visualization system. Based on the segment data metadata, the interest-driven business intelligence server system 112 can group pieces of data in order to create the corresponding segment data than can then be transmitted to an interest-driven data visualization system for exploration. The interest-driven business intelligence server system 112 can also gather several pieces of segment data together into composite segment data so that several pieces of segment data can be analyzed together. Similarly, an interest-driven data visualization system can create segment data and/or composite segment data based on the reporting data present in the interest-driven data visualization system. The segment data (metadata) can be utilized by the interest-driven business intelligence server system 112 and/or interest-driven data visualization system to dynamically generate updated segment data based on changes made to the data (e.g. the source data, aggregate data, event-oriented data, filtered data, and/or reporting data) stored on the system. In this way, segment data (metadata) can also act as a filter to automatically update reports utilizing the segment data based on changes within the data underlying the report.

In many embodiments, the interest-driven business intelligence server system 112 includes reporting data, source data, event-oriented data, and/or aggregate data that partially or fully satisfy the reporting data requirements. The interest-driven business intelligence server system 112 is configured to identify the relevant existing reporting data, aggregate data, event-oriented data, and/or source data and configure an interest-driven data pipeline to create jobs requesting reporting data minimizing the redundancy between the existing data and the new reporting data requirements. In a variety of embodiments, the interest-driven business intelligence server system 112 is configured to determine redundancies between the requested data and existing data using metadata describing the data available from the distributed computing platform 110. In a number of embodiments, the metadata further describes what form the data is available in, such as, but not limited to, aggregate data, filtered data, source data, reporting data, and event-oriented data. In several embodiments, the interest-driven business intelligence server system 112 obtains a plurality of reporting data requirements and creates jobs using the interest-driven data pipeline to create source data containing data fulfilling the union of the plurality of reporting data requirements. In a variety of embodiments, the interest-driven business intelligence server system 112 is configured to identify redundant data requirements in one or more reporting data requirements and configure an interest-driven data pipeline to create jobs requesting source data fulfilling the redundant data requirements. In several embodiments, the interest-driven business intelligence server system 112 is configured to store aggregate data, event-oriented data, and/or reporting data in a data mart and utilize the stored data to identify the redundant data requirements. In a number of embodiments, the interest-driven business intelligence server system 112 is configured to identify when reporting data requirements request updated data for existing reporting data and/or source data and configure an interest-driven data pipeline to create jobs to retrieve an updated snapshot of the existing reporting data from the distributed computing platform 110.

In several embodiments, jobs pushed down to the distributed computing platform 110 by the interest-driven business intelligence server system 112 cannot be executed in a low-latency fashion. In many embodiments, the distributed computing platform 110 is configured to provide a partial set of source data fulfilling the pushed down job and the interest-driven business intelligence server system 112 is configured to create reporting data using the partial set of source data. As more source data is provided by the distributed computing platform 110, the interest-driven business intelligence server system 112 is configured to update the created reporting data based on the received source data. In a number of embodiments, the interest-driven business intelligence server system will continue to update the reporting data until a termination condition is reached. These termination conditions can include, but are not limited to, a certain volume of source data is received, the source data provided is no longer within a particular time frame, and an amount of time to provide the source data has elapsed. In a number of embodiments, a time frame and/or the amount of time to provide the source data is determined based on historical performance metadata describing the time previously measured in the retrieval of source data for similar reporting data requirements.

The interest-driven business intelligence server system 112 is configured to compile an interest-driven data pipeline to create jobs to be pushed down to the distributed computing platform 110 in order to retrieve data. In a variety of embodiments, the jobs created using the interest-driven data pipeline are tailored to the reporting data requirements. In many embodiments, the jobs created using the interest-driven data pipeline are customized to the hardware resources available on the distributed computing platform 110. In a number of embodiments, the jobs are configured to dynamically reallocate the resources available on the distributed computing platform 110 in order to best execute the jobs. In several embodiments, the jobs are created using performance metrics collected based on historical performance metadata describing the performance of previously executed jobs.

Although a specific architecture for an interest-driven business intelligence system in accordance with an embodiment of the invention is conceptually illustrated in FIG. 1, any of a variety of architectures configured to store large data sets and to automatically build interest-driven data pipelines based on reporting data requirements can also be utilized. Systems and methods for interest-driven data visualization systems and segment data in accordance with embodiments of the invention are discussed in detail below.

### Interest-Driven Business Intelligence Server Systems

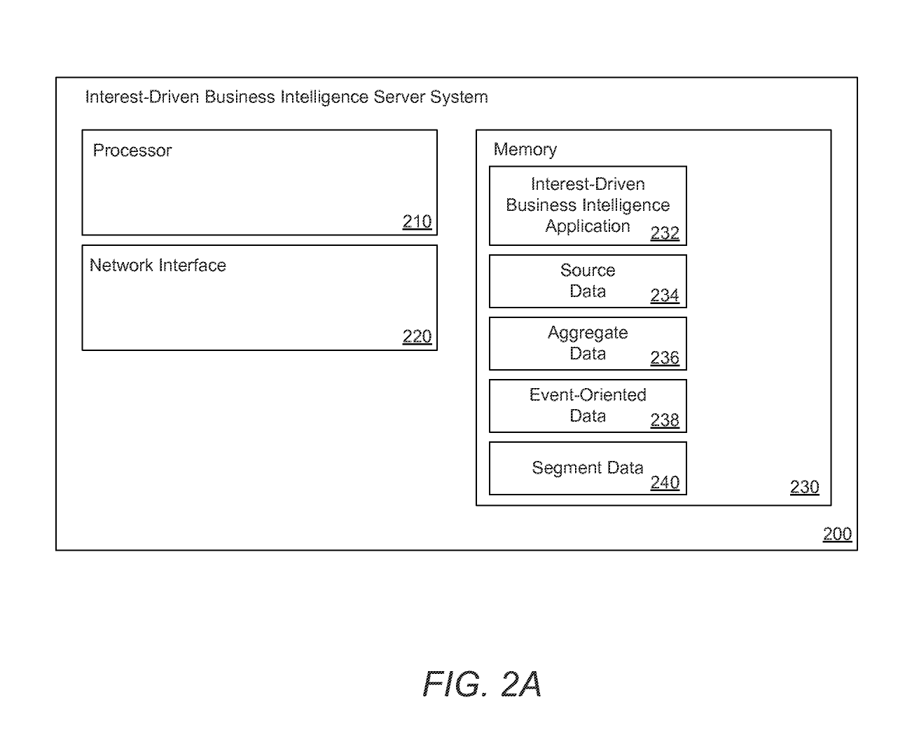

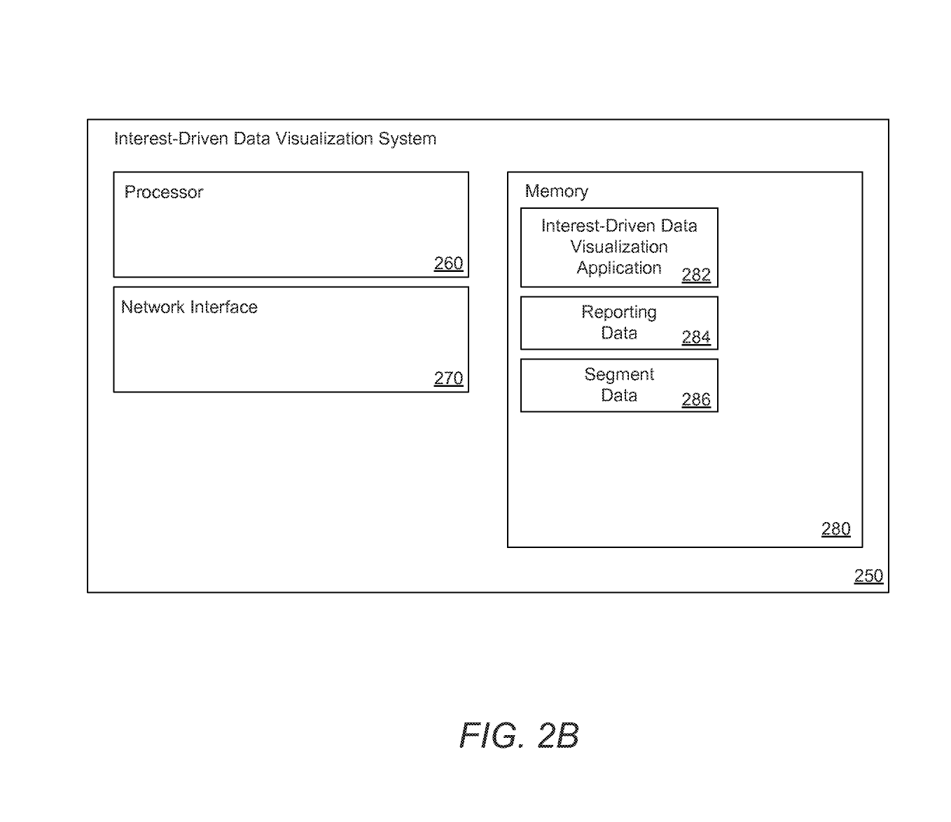

Interest-driven business intelligence server systems in accordance with embodiments of the invention are configured to create jobs to request source data based on received reporting data requirements and to create reporting data using the received source data. Segment data can then be created based on the source data and/or reporting data to facilitate the exploration of groups within the data. An interest-driven business intelligence server system in accordance with an embodiment of the invention is conceptually illustrated in FIG. 2A. The interest-driven business intelligence server system 200 includes a processor 210 in communication with memory 230. The memory 230 is any form of storage configured to store a variety of data, including, but not limited to, an interest-driven business intelligence application 232, source data 234, aggregate data 236, event-oriented data 238, and segment data 240. The interest-driven business intelligence server system 200 also includes a network interface 220 configured to transmit and receive data over a network connection. In a number of embodiments, the network interface 220 is in communication with the processor 210 and/or the memory 230. In many embodiments, the interest-driven business intelligence application 232, source data 234, aggregate data 236, event-oriented data 238, and/or segment data 240 are stored using an external server system and received by the interest-driven business intelligence server system 200 using the network interface 220. External server systems in accordance with a variety of embodiments include, but are not limited to, distributed computing platforms and data marts.

The interest-driven business intelligence application 232 configures the processor 210 to perform an interest-driven business intelligence process. In many embodiments, an interest-driven business intelligence process includes creating jobs using an interest-driven data pipeline to retrieve source data in response to reporting data requirements. The source data can then be utilized to generate aggregate data and/or event-oriented data as appropriate to the requirements of specific applications in accordance with embodiments of the invention. In a variety of embodiments, the created jobs are based on redundancies between reporting data requirements and existing source data 234, aggregate data 236, and/or event-oriented data 238. In a number of embodiments, the interest-driven business intelligence process includes updating reporting data based on incrementally received source data and/or updated source data. The interest-driven business intelligence process further includes generating segment data 240 by grouping portions of the source data 234, aggregate data 236, and/or event-oriented data 238 according to segment grouping data. The segment grouping data can identify one or more dimensions and/or facts within the source data 234, aggregate data 236, and/or event-oriented data 238. In particular, segment grouping data can identify binary segments (e.g. a dimension does or does not exist/have a particular value), multi-valued segments (e.g, dimensions having a value falling within one or more ranges), and quantitative-valued segments (e.g, number of pages clicked). These identified segments can occur across one or more dimensions (individually or in combination) within the source data, aggregate data, and/or event-oriented data. In a variety of embodiments, the segment data 240 includes segment data metadata describing the dimensions of the source data 234, aggregate data 236, and/or event-oriented data 238 that are to be included in the segment data 240. The segment data metadata can also describe any aggregations, filterings, and/or alignments that are to be applied to the source data 234, aggregate data 236, and/or event-oriented data 238 in the creation of segment data 240. Pieces of segment data 240 can also be combined together to form composite segment data describing the data associated with multiple groupings within the data. In many embodiments, the segment data 240 is transmitted to interest-driven data visualization systems.

Although a specific architecture for an interest-driven business intelligence server system in accordance with an embodiment of the invention is conceptually illustrated in FIG. 2A, any of a variety of architectures, including those that store data or applications on disk or some other form of storage and are loaded into memory at runtime, can also be utilized. Systems and methods for interest-driven data visualization systems configured to utilize segment data in accordance with embodiments of the invention are discussed below.

### Interest-Driven Data Visualization Systems

Interest-driven data visualizations systems in accordance with embodiments of the invention are configured to allow the exploration of reporting data. Based on the facts and dimensions within the reporting data, segment data can be defined. The segment data can then be utilized to explore the data associated with one or more groupings of data within the reporting data. An interest-driven data visualization system in accordance with an embodiment of the invention is conceptually illustrated in FIG. 2B. The interest-driven data visualization system 250 includes a processor 260 in communication with memory 280. The memory 280 is any form of storage configured to store a variety of data, including, but not limited to, an interest-driven data visualization application 282, reporting data 284, and segment data 286. The interest-driven data visualization system 250 also includes a network interface 270 configured to transmit and receive data over a network connection. In a number of embodiments, the network interface 270 is in communication with the processor 260 and/or the memory 280. In many embodiments, the interest-driven data visualization application 282, reporting data 284, and segment data 286 are stored using an external server system and received by the interest-driven business data visualization system 250 using the network interface 270. External server systems in accordance with a variety of embodiments include, but are not limited to, interest-driven business intelligence server systems, distributed computing platforms, and data marts.

The interest-driven data visualization application 282 configures the processor 260 to perform an interest-driven data visualization process. The data visualization process includes exploring reporting data 284. Additionally, the data visualization process includes defining segment data metadata based on dimensions and/or facts within the reporting data 284. The segment data metadata can be utilized along with segment grouping data to create segment data 286 based on the reporting data 284. The segment data 286 can be explored as part of the interest-driven data visualization process to create reports facilitating the exploration of the reporting data 284 by analyzing groupings of data within the reporting data 284. Multiple pieces of segment data can be combined together into composite segment data to provide for the comparative exploration of multiple pieces of segment data. In a variety of embodiments, the segment data 286 is obtained from an interest-driven business intelligence server system based on the segment data metadata and/or the grouping data. In many embodiments, the interest-driven data visualization process further includes dynamically creating and/or updating segment data 286 based on the segment data metadata and/or grouping data as reporting data 284 is received and/or updated.

Although a specific architecture for an interest-driven data visualization system in accordance with an embodiment of the invention is conceptually illustrated in FIG. 2B, any of a variety of architectures, including those that store data or applications on disk or some other form of storage and are loaded into memory at runtime, can also be utilized. Interfaces and processes for generating and exploring segment data in accordance with embodiments of the invention are discussed further below.

### Defining Segment Data

Interest-driven data visualization systems provide a variety of interfaces for exploring data obtained from interest-driven business intelligence server systems. During the exploration of data, users can identify particular features within the data may contain interesting details of the data. By grouping these features together and analyzing the grouped features, additional insights into the data can be identified.

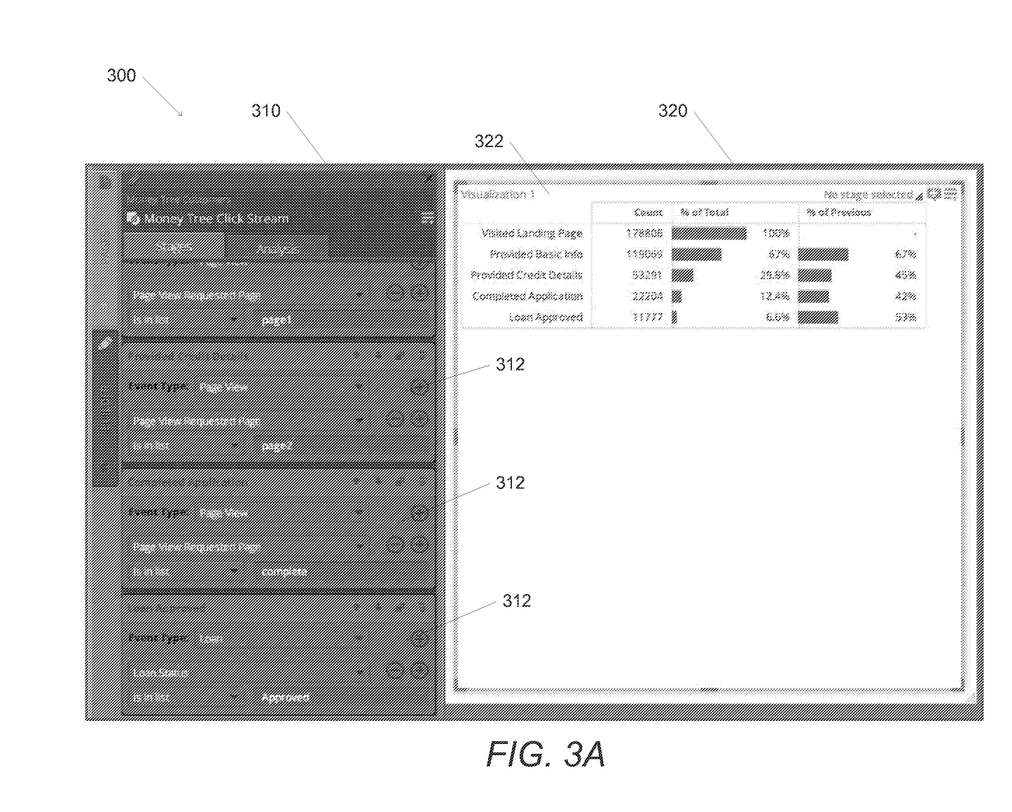

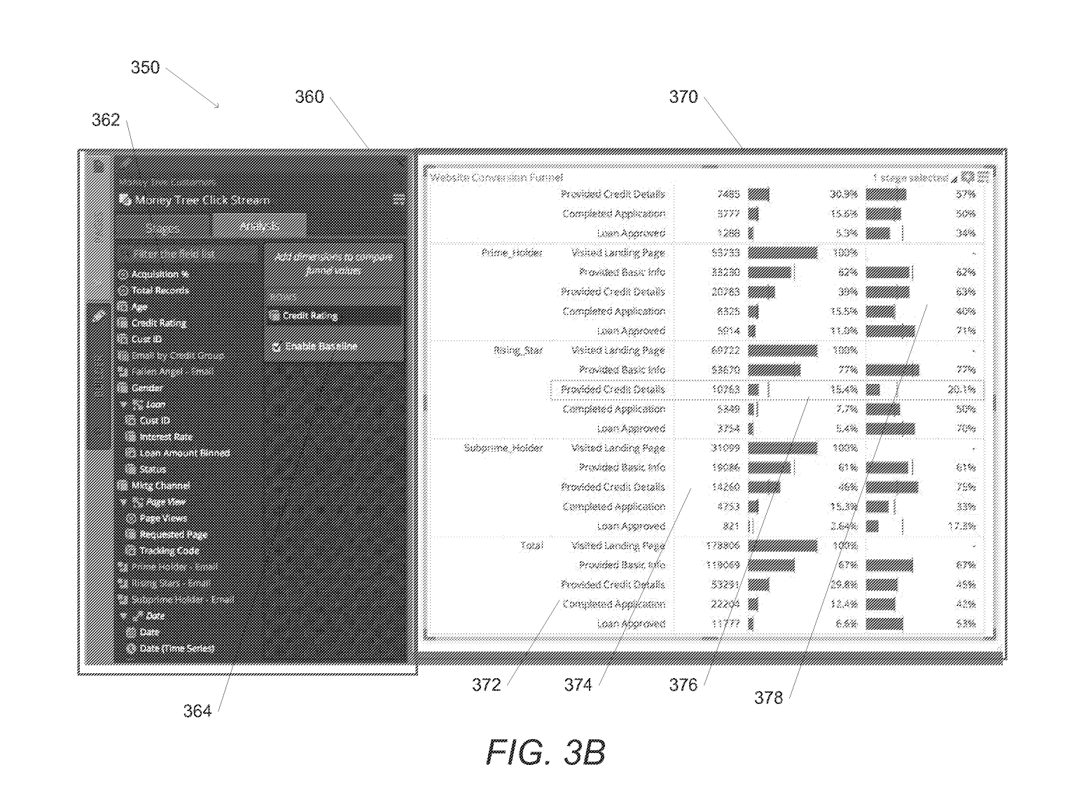

Turning now to FIG. 3A, a conceptual illustration of an interface for defining segment data in accordance with an embodiment of the invention is shown. The reporting data exploration interface 300 includes a segment data definition interface 310 and a segment visualization interface 320. The segment data definition interface 310 includes a plurality of data filters 312 identifying dimensions and facts within the reporting data being explored. The dimensions and facts identified in the data filters 312 are utilized to create segment grouping data that is applied to the reporting data being explored to generate segment data. The segment data is visualized as segment data visualization 322 in the segment visualization interface 320. The segment data visualization 322 includes pieces of data within the reporting data being explored grouped according to the segment grouping data. The segment grouping data can be included in segment data metadata describing the properties of the segment data. The segment data metadata is stored using the interest-driven data visualization system and/or an interest-driven business intelligence server system and can be reused in later explorations of the reporting data.

Turning now to FIG. 3B, a conceptual illustration of an interface for exploring segment data in accordance with an embodiment of the invention is shown. The segment data exploration interface 350 includes a segment selection interface 360 and a combined segment exploration interface 370. The segment selection interface 360 includes a segment data selection interface 362 and a data exploration option interface 364. The segment data selection interface 362 includes a listing of the pieces of reporting data and segment data available to be explored. Composite segment data is defined by choosing one or more pieces of data within the segment data selection interface 362. The data exploration option interface 364 includes a variety of options for filtering the data that is displayed and/or altering the visual properties of the displayed data. The combined segment exploration interface 370 includes a plurality of pieces of segment data 372, 374, 376, and 378 included in the composite segment data. Each piece of segment data displayed represents the data associated with a grouping of data within the reporting data. In this way, the comparative performance of the various groupings of data within the composite segment data can be comparatively analyzed to identify trends within the data across the groups.

While specific examples of interfaces for creating and interacting with segment data are conceptually illustrated above with respect to FIGS. 3A and 3B, any interfaces can be utilized as appropriate to the requirements of specific applications in accordance with embodiments of the invention. Techniques for obtaining and generating segment data in accordance with embodiments of the invention are discussed further below.

### Creating Segment Data

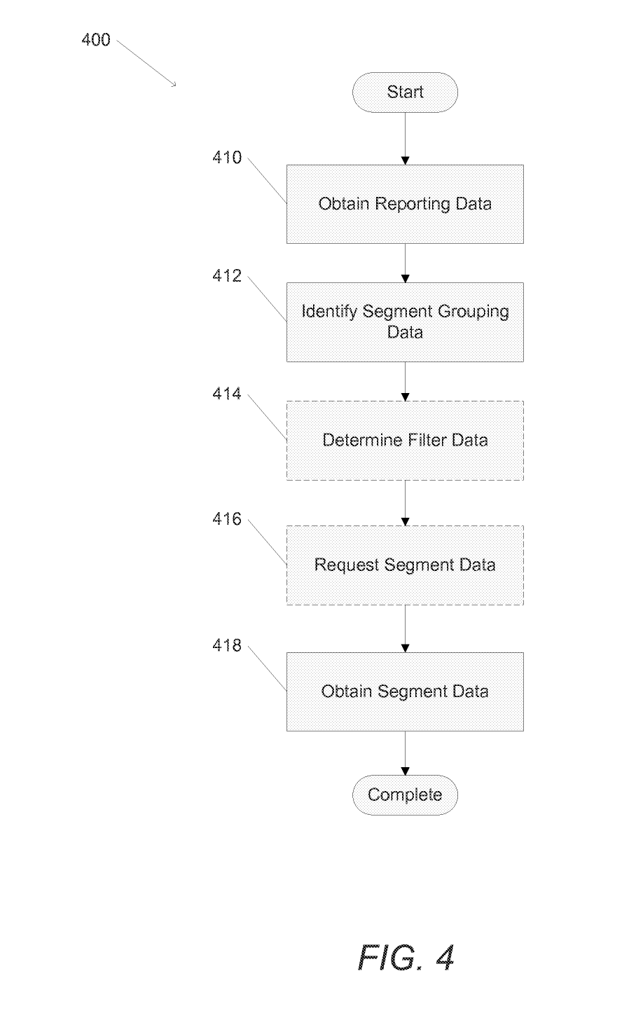

Segment data provides a grouping along one or more dimensions within a set of data. By analyzing a grouping of data, trends within the data associated with the group can be identified. For example, a particular class (e.g. group) of users of a web site may exhibit similar behaviors when interacting with a particular page within the web site that do not correspond to the usage patterns of the majority of the web site users. By identifying these groups of users, their interactions with the web sites can be explored and trends within their behavior can be identified. Interest-driven data visualizations in accordance with embodiments of the invention are configured to obtain the segment data metadata utilized to create segment data. A process for creating segment data in accordance with an embodiment of the invention is illustrated in FIG. 4. The process 400 includes obtaining (410) reporting data and identifying (412) segment grouping data. In several embodiments, filtering data is determined (414) and/or segment data is requested (416). Segment data is obtained (418).

In a variety of embodiments, reporting data is obtained (410) from interest-driven business intelligence server systems. In many embodiments, identifying (412) segment grouping data includes identifying at least one dimension and/or fact within the obtained (410) reporting data. Any reporting data, including aggregate reporting data and event-oriented reporting data, can be utilized as appropriate to the specific requirements of various embodiments of the invention. The segment grouping data can also be identified (412) based on aggregations and/or other values generated based on the dimensions and/or facts, either within the reporting data or externally defined, as appropriate to the requirements of specific applications in accordance with embodiments of the invention. In a number of embodiments, filtering data is utilized to include only pieces of data within the segment data having dimensions and/or facts corresponding to the filtering data. In this way, relevant data can be identified and included in the segment data. In a number of embodiments, the determined (414) filter data is included within segment data metadata. In several embodiments, requesting (416) segment data includes transmitting segment data metadata including the segment grouping data (and the filtering data if applicable) to an interest-driven business intelligence server system. In a variety of embodiments, segment data is obtained (418) from an interest-driven business intelligence server system. In many embodiments, segment data is obtained (418) by applying the identified (412) segment grouping data and/or the determined (414) filter data to reporting data present within an interest-driven data visualization system.

By way of example, the determined (414) filter data can include one or more pieces of user identification data. The filter data can then be utilized to request (416) segment data only including user identification data associated with the determined (414) filter data. Similarly, the determined (414) filter data can include time-based filtering criteria. The filtering process can include mapping the filter data to the requested data in order to account for differences between data sources providing the raw data utilized in the creation of the data used throughout the interest-driven business intelligence server system. Adjustments to data include, but are not limited to, accounting for timing differences between systems and tracking identification information across systems. Adjusting the data can be performed by shifting the data to a common format and/or by performing mappings of data to a common set of data. For example, with respect to time-based data, data acquired from multiple sources can all be converted to Coordinated Universal Time (UTC) in order to account for different time bases across systems. Similarly, time-based data can be adjusted based on threshold values to account for timing differences between the system clocks of a variety of systems providing data. Additionally, with respect to identification-based data (e.g. user identification data), a variety of universal tracking information can be utilized to map identification-based data to the universal tracking information in order to account for differences between the identification-based data across the systems providing the data. In this way, users can be identified across disparate systems (and disparate portions within a system) in order to provide the ability to analyze the user's data across the systems. It should be noted, however, that any filtering process can be utilized as appropriate to the requirements of specific applications in accordance with embodiments of the invention.

Although a specific process for creating segment data is described above with respect to FIG. 4, any of a variety of processes, including those that create segment data based on dimensions and/or facts not within the reporting data, can be utilized in accordance with embodiments of the invention. Processes for creating composite segment data in accordance with embodiments of the invention are discussed further below.

### Creating Composite Segment Data

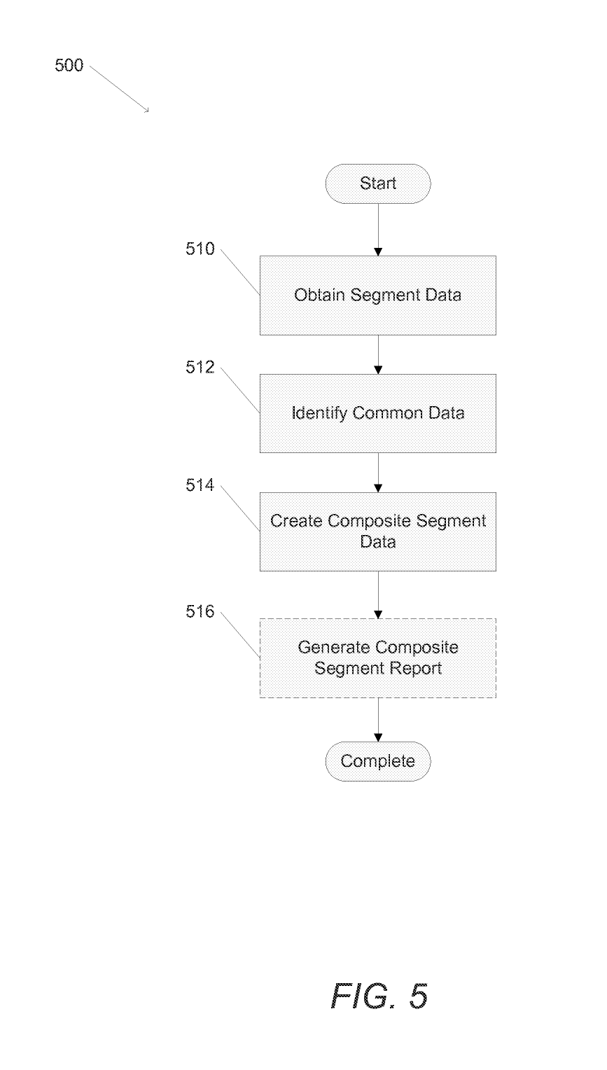

During the exploration of data, it is often useful to compare a variety of groupings of data to compare trends across the groups of data. Composite segment data can be created that associate multiple groupings of data. The groupings of data can be created concomitant with the composite segment data; however, composite segment data is commonly created based on previously created segment data. Returning to the example above with respect to FIG. 4, multiple pieces of segment data (each identifying a grouping of users within the web site) can be grouped together to comparatively explore the interactions each group of users has with the web site. Interest-driven data visualization systems in accordance with embodiments of the invention are configured to associate groupings of segment data and provide an interface for exploring the groupings of data. A process for creating composite segment data in accordance with an embodiment of the invention is illustrated in FIG. 5. The process 500 includes obtaining (510) segment data and identifying (512) common data. Composite segment data is created (514) and, in several embodiments, composite segment reports are generated (516).

In a number of embodiments, segment data is obtained (510) utilizing processes similar to those described above. In several embodiments, common data is identified (512) based on the dimensions and/or facts contained within the obtained (510) segment data. In a variety of embodiments, composite segment data is created (514) based on the obtained (510) pieces of segment data that have the identified (512) common data in common. In many embodiments, the created (514) composite segment data contains pieces of segment data that have facts within a threshold value of the identified (512) common data. The threshold values can be pre-determined and/or determined dynamically based on the pieces of segment data as appropriate to the requirements of specific applications in accordance with embodiments of the invention. In a number of embodiments, a composite segment report is generated (516) based on the created (514) composite segment data utilizing techniques similar to those described above.

A specific process for creating composite segment data is described above with respect to FIG. 5; however, any of a variety of processes, including those that create composite segment data utilizing other data in addition to segment data, can be utilized in accordance with embodiments of the invention. Techniques for generating segment data in accordance with embodiments of the invention are described below.

### Generating Segment Data

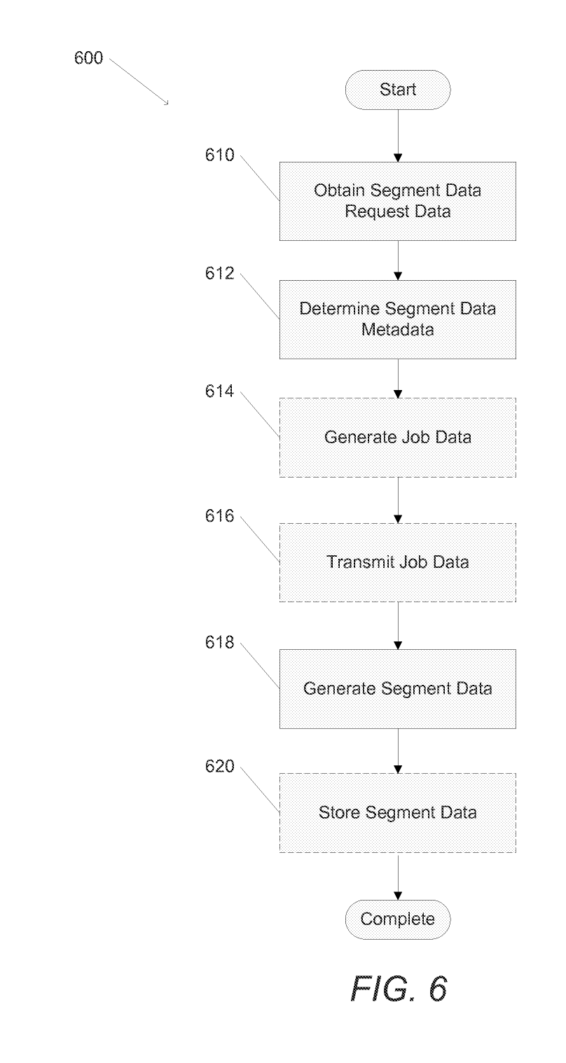

As described above, segment data provides a grouping of data. In several embodiments, segment data is utilized to automatically filter a portion of data according to the segment data. Interest-driven business intelligence server systems in accordance with embodiments of the invention are configured to generate segment data. A process for generating segment data in accordance with an embodiment of the invention is illustrated in FIG. 6. The process 600 includes obtaining (610) segment data request data and determining (612) segment data metadata. In several embodiments, job data is generated (614) and/or job data is transmitted (616). Segment data is generated (618) and, in a number of embodiments, segment data is stored (620).

In a variety of embodiments, segment data request data is obtained (610) from an interest-driven data visualization system. The segment data request data includes segment data metadata and/or segment grouping data identifying the dimensions and/or facts of the requested segment data. The segment data request can identify one or more pieces of segment data. In many embodiment, segment data metadata is determined (612) based on the obtained (610) segment data request data. In a number of embodiments, determining (612) segment data metadata includes mapping the fact and/or dimensions defined in the segment data request data to facts and/or dimensions present in the source data stored in the interest-driven business intelligence server system. In several embodiments, the segment data request data includes facts and/or dimensions that are not present in the source data available. Job data is generated (614) to obtain the facts and/or dimensions that are not present. In a number of embodiments, job data is generated (614) to request updated source data corresponding to the determined (612) segment data metadata. In many embodiments, the job data is transmitted (616) to a distributed computing platform and additional and/or updated source data is obtained in response to the transmitted (616) job. In a variety of embodiments, segment data is generated (618) based on the determined (612) segment data metadata and the source data present in the interest-driven business intelligence server system. In several embodiments, the generated (618) segment data is stored (620) so that the segment data can be provided later. In a number of embodiments, the determined (612) segment data metadata is stored. In this way, the segment data metadata can be utilized to generate additional pieces of segment data at later time. For example, the segment data metadata can be used to generate additional segment data as the underlying source data changes over time.

Although a specific process for generating segment data is described above with respect to FIG. 6, any of a variety of processes, including those that store segment data using alternative techniques to those described above, can be utilized in accordance with embodiments of the invention. In particular, the processes described above can be utilized by interest-driven data visualization systems to generate segment data utilizing reporting data present within the interest-driven data visualization system. Processes for generating reporting data based on segment data in accordance with embodiments of the invention are discussed further below.

### Generating Reporting Data Using Segment Data

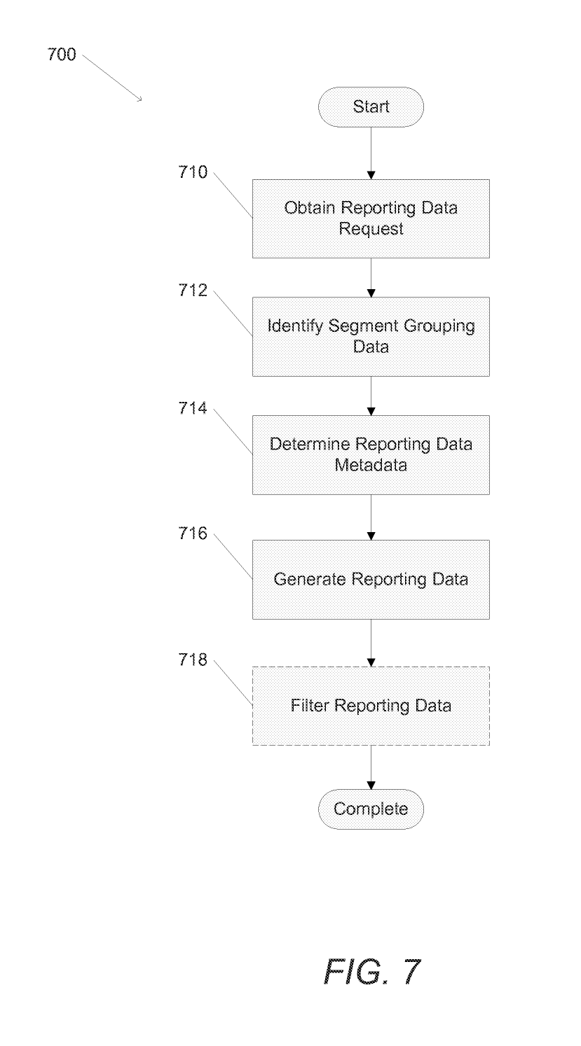

Once trends have been identified within one or more pieces of segment data, it is often useful to analyze reporting data generated based on the identified trends. In this way, the reporting data provides additional information regarding the identified trends. Returning to the example described above with respect to FIGS. 4 and 5, once a particular portion of the web site is identified based on the interaction of the groups of users with the portion of the web site, reporting data describing that portion of the web site can be obtained. Based on the reporting data, additional explorations with respect to that portion of the web site can be performed including additional information not present in the original segment data. Interest-driven business intelligence server systems in accordance with embodiments of the invention are configured to generate reporting data based on segment data. A process for generating reporting data based on segment data in accordance with an embodiment of the invention is illustrated in FIG. 7. The process 700 includes obtaining (710) a reporting data request and identifying (712) segment grouping data. Reporting data metadata is determined (714) and reporting data is generated (716). In a number of embodiments, reporting data is filtered (718).

In many embodiments, the obtained (710) reporting data request includes segment data metadata describing the facts and/or dimensions of (composite) segment data. In a variety of embodiments, segment grouping data is identified (712) based on the segment data metadata. In several embodiments, segment grouping data is identified (712) by mapping facts and/or dimensions identified in the obtained (710) reporting data request to source data present in an interest-driven business intelligence server system. In a number of embodiments, reporting data metadata is determined (714) based on the obtained (710) reporting data request and/or the identified (712) segment grouping data. In many embodiments, reporting data is generated (716) based on the determined (714) reporting data metadata and the source data. Generating (716) reporting data can also include obtaining additional source data from a distributed computing platform utilizing techniques similar to those described above as appropriate to the requirements of specific applications in accordance with embodiments of the invention. In a variety of embodiments, the reporting data is filtered (718) according to the identified (712) segment grouping data. In this way, the generated (716) reporting data can be targeted toward the segment data identified in the obtained (710) reporting data request. Filtering (718) of the reporting data can occur before and/or after the reporting data is generated as appropriate to the requirements of specific applications in accordance with embodiments of the invention. Filtering (718) can include selecting and/or grouping a portion of the reporting data based on the segment grouping data.

Specific processes for generating reporting data based on segment data are described above with respect to FIG. 7; however, any of a variety of processes, including those that generate reporting data utilizing processes other than those described above, can be utilized in accordance with embodiments of the invention. In particular, the processes described above can be utilized by interest-driven data visualization systems to generate reporting data based on segment data utilizing reporting data present within the interest-driven data visualization system. Additionally, any of the various processes described above can be performed in alternative sequences and/or in parallel (on different computing devices) in order to achieve similar results in a manner that is more appropriate to the requirements of a specific application.

Although the present invention has been described in certain specific aspects, many additional modifications and variations would be apparent to those skilled in the art. It is therefore to be understood that the present invention can be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

1. An interest-driven data visualization system, comprising:
a processor; and
a memory connected to the processor and configured to store an interest-driven data visualization application;
wherein the interest-driven data visualization application configures the processor to:
define reporting data requirements, where the reporting data requirements comprise at least one piece of reporting data metadata;
generate data retrieval job data based on the at least one piece of reporting data metadata in the reporting data requirements and the data description metadata;
transmit the data retrieval job data to an interest-driven business intelligence server system;
receive source data from the interest-driven business intelligence server system, where the source data is generated based on raw data and metadata describing the raw data;
create at least one piece of reporting data using the received source data, the data description metadata, and the reporting data metadata; and
generate a set of segment data based on the reporting data, where a piece of segment data in the set of segment data comprises a subset of the reporting data.

2. The interest-driven data visualization system of claim 1, wherein the source data comprises data selected from the group consisting of aggregate data and event-oriented data.

3. The interest-driven data visualization system of claim 1, wherein the interest-driven data visualization application further configures the processor to:
associate visualization metadata with the segment data, where the visualization metadata describes the visual appearance of the at least one piece of segment data; and
generate a report using the at least one piece of segment data and the visualization metadata, where the generated report is configured to be displayed using a display device.

4. The interest-driven data visualization system of claim 1, wherein the interest-driven data visualization application configures the processor to:
generate supplemental data retrieval job data identifying additional source data;
transmit the supplemental data retrieval job data to the interest-driven business intelligence server system;
receive supplemental source data from the interest-driven business intelligence server system;
update at least one piece of the at least one piece of reporting data using the supplemental source data, the data description metadata, and the reporting data metadata; and
generate at least one piece of updated segment data in the set of segment data based on the updated reporting data.

5. The interest-driven data visualization system of claim 4, wherein the interest-driven data visualization application further configures the processor to generate an updated report using the at least one piece of updated segment data and the visualization metadata, where the generated report is configured to be displayed using a display device.

6. The interest-driven data visualization system of claim 1, wherein the interest-driven data visualization application further configures the processor to:
identify common data between a plurality of pieces of segment data within the set of segment data; and
generate a set of composite segment data comprising a portion of the pieces of segment data sharing the identified common data.

7. The interest-driven data visualization system of claim 6, wherein the interest-driven data visualization application further configures the processor to:
associate visualization metadata with the composite segment data, where the visualization metadata describes the visual appearance of the at least one piece of composite segment data; and
generate a composite segment report based on the at least one piece of composite segment data and the visualization metadata, where the composite segment report is configured to be displayed using a display device.

8. The interest-driven data visualization system of claim 1, wherein the interest-driven data visualization application configures the processor to generate a set of segment data by:
identifying segment grouping data based on the reporting data metadata and the reporting data; and
grouping the reporting data based on the segment grouping data.

9. The interest-driven data visualization system of claim 1, wherein the segment grouping data identifies at least one dimension within the reporting data.

10. The interest-driven data visualization system of claim 8, wherein:
the segment data comprises a subset of the reporting data having at least one dimension satisfying a portion of the segment grouping data; and
the segment grouping data identifies a set of data within the reporting data selected from the group consisting of dimension data and fact data.

11. The interest-driven data visualization system of claim 8, wherein the interest-driven data visualization application further configures the processor to generate a set of segment data by:
determining filter data, where the filter data identifies a portion of the reporting data; and
filtering the reporting data utilized in the grouping of the reporting data based on the segment grouping data.

12. The interest-driven data visualization system of claim 8, wherein the interest-driven data visualization application further configures the processor to generate a set of segment data by:
creating segment data metadata describing the desired segment data, where the segment data metadata comprises the segment grouping data;
creating segment data request data comprising the segment data metadata;
transmitting the segment data request data to an interest-driven business intelligence server system; and
obtaining the segment data from the interest-driven business intelligence server system.

13. The interest-driven data visualization system of claim 1, wherein the interest-driven data visualization application further configures the processor to:
identify at least one piece of segment data in the set of segment data;
generate segment data retrieval job data based on the at least one piece of segment data;
transmit the segment data retrieval job data to the interest-driven business intelligence server system;
obtain additional source data corresponding to the segment data retrieval job data; and
generate segment reporting data based on the additional source data.

14. An interest-driven business intelligence system, comprising:
raw data storage configured to contain raw data and perform extract, transform, and load (ETL) processes, where the raw data comprises unstructured data;
a data mart configured to contain metadata that describes the raw data; and
an intermediate processing layer;
wherein the intermediate processing layer is configured to automatically:
generate metadata describing the raw data;
derive reporting data requirements from at least one report specification based on the metadata; and
compile an interest-driven data pipeline based upon the reporting data requirements; and
wherein compiling the interest-driven data pipeline comprises:
generating ETL processing jobs to generate source data from the raw data by:
filtering the raw data using the structure of the raw data;
applying transformations to the raw data based on the structure of the raw data; and
storing the source data in the data mart; and
generate a set of segment data based on segment data metadata and the generated source data.

15. The interest-driven business intelligence system of claim 14, wherein the source data comprises data selected from the group consisting of aggregate data and event-oriented data.

16. The interest-driven business intelligence system of claim 14, wherein the intermediate processing layer is further configured to:
generate supplemental source data utilizing the interest-driven data pipeline; and
generate at least one piece of updated segment data in the set of segment data based on the segment data metadata and the supplemental source data.

17. The interest-driven business intelligence system of claim 14, wherein the intermediate processing layer is further configured to:
identify common data between a plurality of pieces of segment data within the set of segment data; and
generate a set of composite segment data comprising a portion of the pieces of segment data sharing the identified common data.

18. The interest-driven business intelligence system of claim 14, wherein the intermediate processing layer is further configured to generate a set of segment data by:
identifying segment grouping data based on the segment data metadata; and
grouping the source data based on the segment grouping data.

19. The interest-driven business intelligence system of claim 18, wherein the segment grouping data identifies at least one dimension within the source data.

20. The interest-driven business intelligence system of claim 18, wherein:
the segment data comprises a subset of the reporting data having at least one dimension satisfying a portion of the segment grouping data; and
the segment grouping data identifies a set of data within the reporting data selected from the group consisting of dimension data and fact data.

21. The interest-driven business intelligence system of claim 18, wherein the intermediate processing layer is further configured to generate a set of segment data by:
determining filter data, where the filter data identifies a portion of source data; and
filtering the source data utilized in the grouping of the source data based on the segment grouping data.

22. The interest-driven business intelligence system of claim 14, wherein the intermediate processing layer is further configured to:
obtain segment data request data, where the segment data request data comprises segment data metadata comprising segment grouping data; and
generate the set of segment data based on the segment data metadata and the source data present in the data mart.

23. The interest-driven business intelligence system of claim 22, wherein the intermediate processing layer is further configured to:
identify additional source data based on the segment data metadata, where the additional source data is not present in the data mart;
generate ETL processing jobs to generate the additional source data;
obtaining the additional source data by transmitting the generated ETL processing jobs to the raw data storage; and
generating at least one piece of segment data in the set of segment data based on the additional source data.

24. The interest-driven business intelligence system of claim 22, wherein:
the segment data request data further comprises filtering data; and
the intermediate processing layer is further configured to filter the source data utilized in the generation of the set of segment data based on the filtering data.

25. The interest-driven business intelligence system of claim 22, wherein:
the segment data request data further comprises metadata identifying an interest-driven data visualization system; and
the intermediate processing layer is further configured to transmit the generated segment data to the identified interest-driven data visualization system.

26. The interest-driven business intelligence system of claim 14, wherein the intermediate processing layer is further configured to:
obtain segment data retrieval job data, where the segment retrieval job data identifies at least one piece of segment data;
identify additional source data based on the segment data metadata and the source data contained within the data mart;
when the additional source data is not present in the data mart:
generate ETL processing jobs to generate the additional source data; and
obtain the additional source data by transmitting the generated ETL processing jobs to the raw data storage; and
generate at least one piece of source data based on the segment data retrieval job data and the additional source data.

27. A method for creating interest-driven data visualizations with segment data, comprising:
defining reporting data requirements using an interest-driven data visualization system, where the reporting data requirements comprise at least one piece of reporting data metadata;
generating data retrieval job data based on the at least one piece of reporting data metadata in the reporting data requirements and the data description metadata using the interest-driven data visualization system;
transmitting the data retrieval job data to an interest-driven business intelligence server system using the interest-driven data visualization system;
receiving source data from the interest-driven business intelligence server system using the interest-driven data visualization system, where the source data is generated based on raw data and metadata describing the raw data;
creating at least one piece of reporting data based on the received source data, the data description metadata, and the reporting data metadata using the interest-driven data visualization system; and
generating a set of segment data based on the reporting data using the interest-driven data visualization system, where a piece of segment data in the set of segment data comprises a subset of the reporting data.
